(19) United States
(12) Patent Application Publication
(10) Pub. No.: US 2016/0261935 A1
(43) Pub. Date: Sep. 8, 2016

(54) CENTRAL BASE STATION APPARATUS CAPABLE OF DYNAMICALLY ALLOCATING MULTIPLE WAVELENGTHS

(71) Applicant: ELECTRONICS AND TELECOMMUNICATIONS RESEARCH INSTITUTE, Daejeon-si (KR)

(72) Inventors: Jun Seong BANG, Daejeon-si (KR); Seung Hwan KIM, Daejeon-si (KR); Yong Uk WON, Paju-si (KR)

(21) Appl. No.: 15/059,496

(22) Filed: Mar. 3, 2016

(30) Foreign Application Priority Data
Mar. 6, 2015 (KR) 10-2015-0031347

(51) Int. Cl. H04Q 11/00; H04B 10/25

(52) U.S. Cl. CPC H04Q 11/0062; H04B 10/2503; H04Q 11/0067; H04Q 2011/0086

(57) ABSTRACT

A central base station apparatus includes: a network communicator configured to transmit and receive a signal with separated-type base stations; and a dynamic wavelength allocator configured to dynamically allocate one or more wavelengths to the separated-type base stations through the network communicator based on bandwidth request information of each of the separated-type base stations.

### CROSS-REFERENCE TO RELATED APPLICATION(S)

This application claims priority from Korean Patent Application No. 10-2015-0031347, filed on Mar. 6, 2015, in the Korean Intellectual Property Office, the entire disclosure of which is incorporated herein by reference for all purposes.

### BACKGROUND

1. Field

The following description generally relates to an optical backhaul/fronthaul network system for supporting separated-type base stations.

2. Description of the Related Art

In a general optical backhaul/fronthaul network system, a central base station provides an optical link to a separated-type base station by using an upstream wavelength and a downstream wavelength. Control information and data may be transmitted and received between the central base station and the separated-type base station over downstream/upstream wavelengths, and a control channel may have other wavelength, as described in “An Agile and Medium-Transparent MAC protocol for 60 GHz radio-over-fiber local access networks”. Journal of Lightwave Technology, Vol. 28, No. 16, 2010, G. Kalfas et al. That is, in the existing system, capacity of mobile data transmission of the separated-type base station in a wavelength is a maximum service speed.

Mobile traffic generated by each separated-type base station does not always require a maximum amount of bandwidth resources of an allocated wavelength, but at some point in time, may require an amount of bandwidth resources that is greater than a transmission capacity available in a wavelength.

Mobile traffic tends to be concentrated on some separated-type base stations according to a moving pattern of a mobile device user. Conventionally, one data wavelength is allocated to each separated-type base station, such that when mobile traffic is concentrated on a separated-type base station, the separated-type base station may not transmit data having an amount greater than a maximum transmission capacity available in a wavelength. By contrast, in the case where utilization of wavelengths is low, wavelength resources are wasted.

### SUMMARY

The present disclosure enables transmission of a large amount of traffic by allocating one or more wavelength resources to separated-type base stations according to needs.

In one general aspect, there is provided a central base station apparatus, including: a network communicator configured to transmit and receive a signal with separated-type base stations; and a dynamic wavelength allocator configured to dynamically allocate one or more wavelengths to the separated-type base stations through the network communicator based on bandwidth request information of each of the separated-type base stations.

The dynamic wavelength allocator may determine a number of upstream wavelength resources to be allocated to the separated-type base stations according to the bandwidth request information based on an amount of used traffic of the separated-type base stations.

The network communicator may include: a first optical transceiver configured to allocate a control wavelength; and a second optical transceiver configured to allocate a data wavelength.

After allocating wavelength resources through the first optical transceiver, the dynamic wavelength allocator may allocate a number of wavelength resources, determined according to the amount of used traffic of the separated-type base stations, through the second optical transceiver.

The first optical transceiver may be a single optical transceiver to allocate one wavelength resource; and the second optical transceiver may include a plurality of optical transmission modules to allocate different wavelength resources.

The first optical transceiver may be a broadcast optical module; and the second optical transceiver may be a unicast optical module.

The dynamic wavelength allocator may allocate upstream wavelength resources while transmitting a downstream signal to the separate-type base stations.

A broadcast control channel may be used to exchange wavelength allocation information and the bandwidth request information between the central base station and the separated-type base stations.

The dynamic wavelength allocator may allocate the wavelength resources to the separated-type base stations through the second optical transceiver by using synchronized superframes of wavelengths.

### BRIEF DESCRIPTION OF THE DRAWINGS

FIG. 1 is a block diagram illustrating a central base station apparatus according to an exemplary embodiment.

FIG. 2 is a diagram illustrating a network structure in a tree-type topology according to an exemplary embodiment.

FIG. 3 is a diagram illustrating a network structure in a ring-type topology according to an exemplary embodiment.

FIGS. 4 and 5 are block diagrams illustrating the central base station illustrated in FIG. 1 according to an exemplary embodiment.

FIG. 6 is a block diagram illustrating a separated-type base station according to an exemplary embodiment.

FIG. 7 is a diagram illustrating synchronized superframes of multiple wavelengths according to an exemplary embodiment.

FIG. 8 is a diagram illustrating a superframe having a plurality of allocation slots according to an exemplary embodiment.

FIG. 9 is a diagram illustrating an allocation slot having a plurality of data slots according to an exemplary embodiment.

FIG. 10 is a diagram illustrating an allocation slot of a control wavelength according to an exemplary embodiment.

FIG. 11 is a diagram illustrating a Request Window procedure according to an exemplary embodiment.

FIG. 12 is a flowchart illustrating a wavelength allocation method of a central base station according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein, Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, exemplary embodiments of the central base station apparatus capable of dynamically allocating multiple wavelengths will be described in detail with reference to the following drawing.

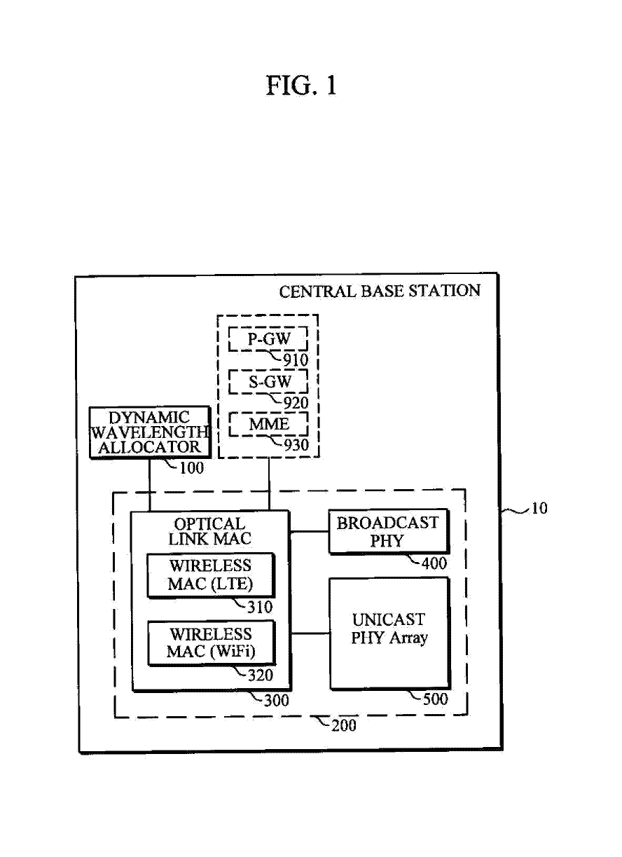

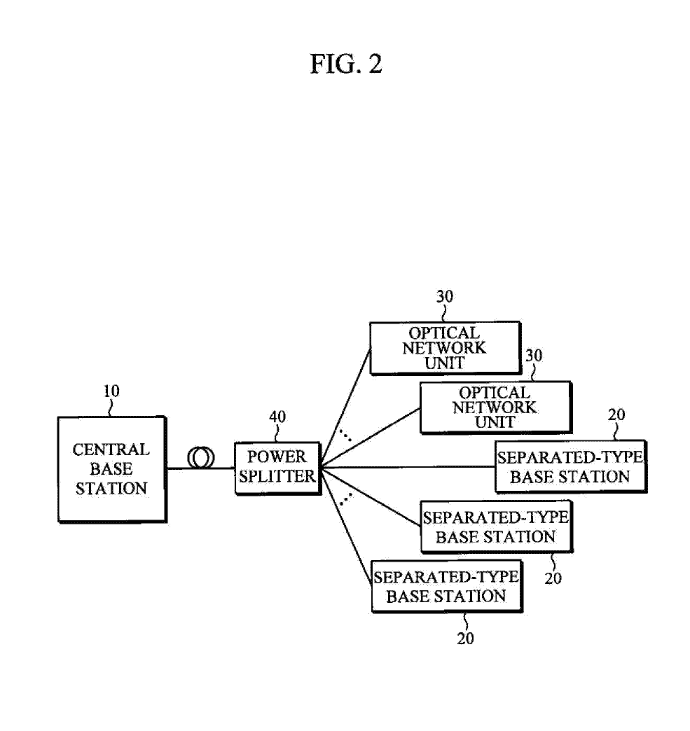

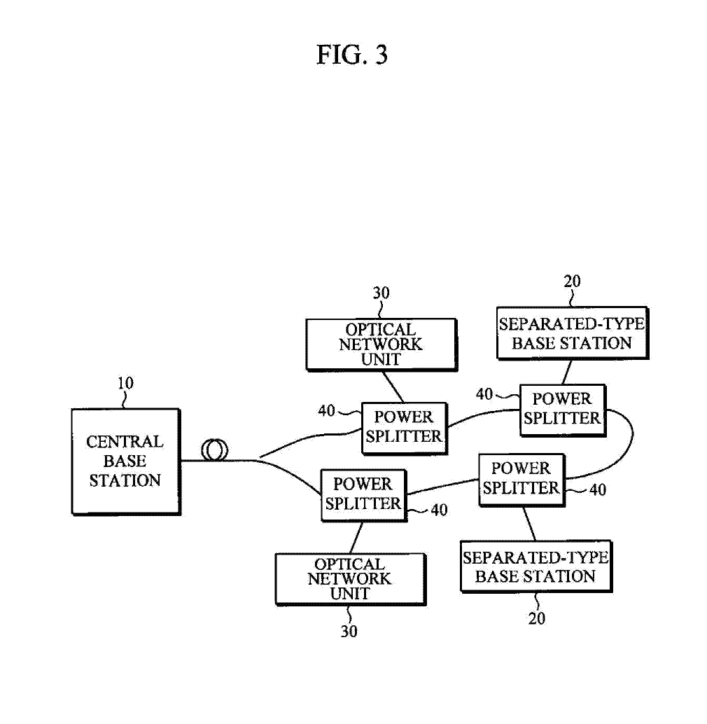

FIG. 1 is a block diagram illustrating a central base station apparatus according to an exemplary embodiment. The central base station apparatus 10 (hereinafter referred to as a “base station”) may dynamically allocate one or more wavelengths to separated-type base stations. A network structure for the allocation may be a tree-type topology or a ring-type topology. FIG. 2 is a diagram illustrating a network structure in a tree-type topology according to an exemplary embodiment, and FIG. 3 is a diagram illustrating a network structure in a ring-type topology according to an exemplary embodiment. In the ring-type topology, a plurality of power splitters 40 are used to receive multiple wavelengths, which limits the number of acceptable separated-type base stations and coverage of a network.

The central base station 10 includes a dynamic wavelength allocator 100 and a network communicator 200. The central base station 100 operates similarly to a BaseBand Unit (BBU) in a C-RAN architecture, but in a larger sense, the central base station 100 may be considered a module that controls wavelength resources for different wired and wireless networks. In the case where an optical network unit (ONU) 30 of a passive optical network (PON) is located at a position of a separated-type base station 20, the central base station 10 may be configured to externally include an optical link MAC unit 300 and to internally include different wireless MACs 310 and 320 such as LTE or WiFi.

The network communicator 200 may include a MAC/PHY unit that is composed of a MAC unit and a PHY unit. As described above, the MAC unit may externally include the optical link MAC unit 300, and may internally include different wireless MACs 310 and 320 such as LTE or WiFi. The PHY unit may include a first optical transceiver 400 and a second optical transceiver 500. The first optical transceiver 400 is used for a control channel, and the second optical transceiver 500 is used for a data channel. As illustrated in FIG. 1, the first optical transceiver 400 may be a broadcast optical module, and the second optical transceiver 500 may be a unicast optical module array. Data may be transmitted through the broadcast optical module 400 or the unicast optical module array 500 to the separated-type base stations 20.

The central base station 10 may use the first optical transceiver 400 to exchange wavelength allocation information and bandwidth request information with the separated-type base stations 20. The dynamic wavelength allocator 100 may dynamically allocate one or more wavelength resources to each of the separated-type base stations 20 based on the wavelength request information received from the separated-type base stations 20. That is, based on the bandwidth request information received from the separated-type base stations 20, the dynamic wavelength allocator 100 may determine a number of wavelengths to be allocated to the separated-type base stations 20, and may transmit the wavelength allocation information, which includes information on the determined number of wavelength resources, to the separated-type base stations 20. The bandwidth request information includes information on an amount of bandwidth requested according to an amount of traffic used by the separated-type base stations. Further, the wavelength allocation information includes information on wavelength resources to be allocated. For example, the wavelength allocation information includes wavelength indices and time windows. Further, wavelength resources, which are dynamically allocated, refer to upstream wavelength resources.

In one exemplary embodiment, the dynamic wavelength allocator 100 allocates wavelength resources through the first optical transceiver 400, determines a number of wavelength resources according to an amount of bandwidth requested by the separated-type base stations 20, and then additionally allocates the determined number of wavelength resources through the second optical transceiver 500. As described above, the separated-type base stations 20 are required to receive the wavelength allocation information and other control signals, and to transmit the bandwidth request information. As such information uses a very small amount of bandwidth, a control channel is provided separately, in which one wavelength resource is shared by time division. Portions other than a control signal in the broadcast channel may be time-divided for data transmission. The unicast channel may be used to allocate one or more wavelengths to the separated-type base stations 20 that require additional wavelength resources. The central base station 10 retrieves unused resources.

The central base station 10 may include at least one or more of a packet gateway (P-GW) 910 for mobile services, a serving gateway (S-GW) 920, and a Mobility Management Entity (MME) 930. By locating the P-GW 910, the S-GW 920, and the MME 930 in the central base station 10, latency of communications may be prevented. Specifically, a traffic request by the separated-type base stations 20 follows a behavior pattern of mobile device users. In other words, request, acceptance, and handover of mobile services are made all together, such that if such information may be processed at the central base station 10 without need to be transmitted to a mobile core, low-latency communication services may be provided. Further, in the central base station operated based on a wireless MAC protocol, with no processing module being provided for the separated-type base station, the wireless header information may be decoded on the protocol.

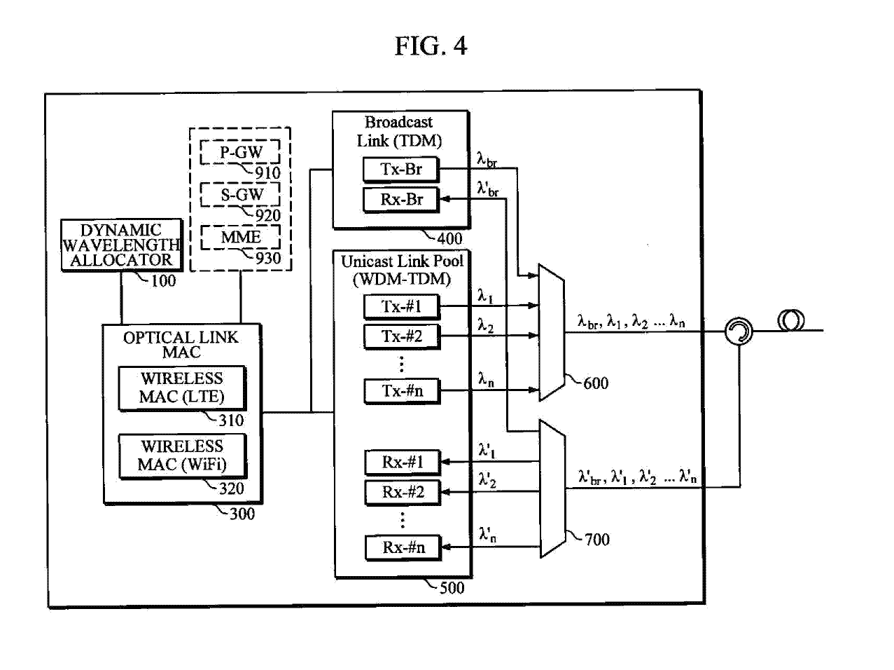

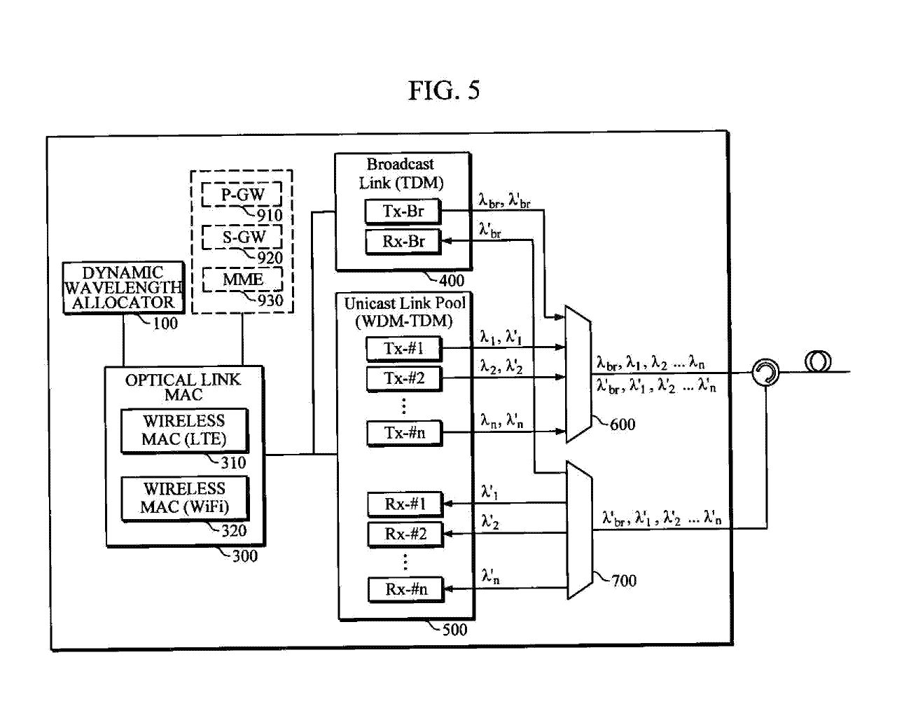

FIGS. 4 and 5 are block diagrams illustrating the central base station illustrated in FIG. 1 according to an exemplary embodiment. As illustrated in FIG. 4, devices of the central base station 10 are a broadcast optical module 400 including a single optical transceiver, and a unicast optical module array 500 including a plurality of transmitters (Tx) and receivers (Rx). The unicast optical module array 500 may use a tunable optical module and a fixed-type optical module. Wavelengths are collected by a multiplexer to be transmitted downstream, and classified by a demultiplexer 700 as an upstream wavelength to be received by the central base station 10. Each unicast optical module included in the unicast optical module array 500 transmits signals upstream/downstream by using different wavelengths. In the case where the dynamic wavelength allocator 100 retrieves wavelength resources, the dynamic wavelength allocator 100 may convert the unicast optical modules, which used the retrieved wavelength resources, from a normal operation mode into a power saving mode.

As in the embodiment of FIG. 4, FIG. 5 illustrates the broadcast optical module 400, and the unicast optical module array 500 including a plurality of transmitters (Tx) and receivers (Rx). In the unicast optical module array 500, a tunable optical module and a fixed-type optical module may be used. In FIG. 5, however, unlike the embodiment of FIG. 4, the central base station 10 allocates upstream wavelength resources while transmitting a downstream signal to the separate-type base stations. While an optical module for upstream transmission to the separated-type base stations 20 is required in the embodiment of FIG. 4, such optical module is not needed in FIG. 5, requiring only a modulator for upstream transmission.

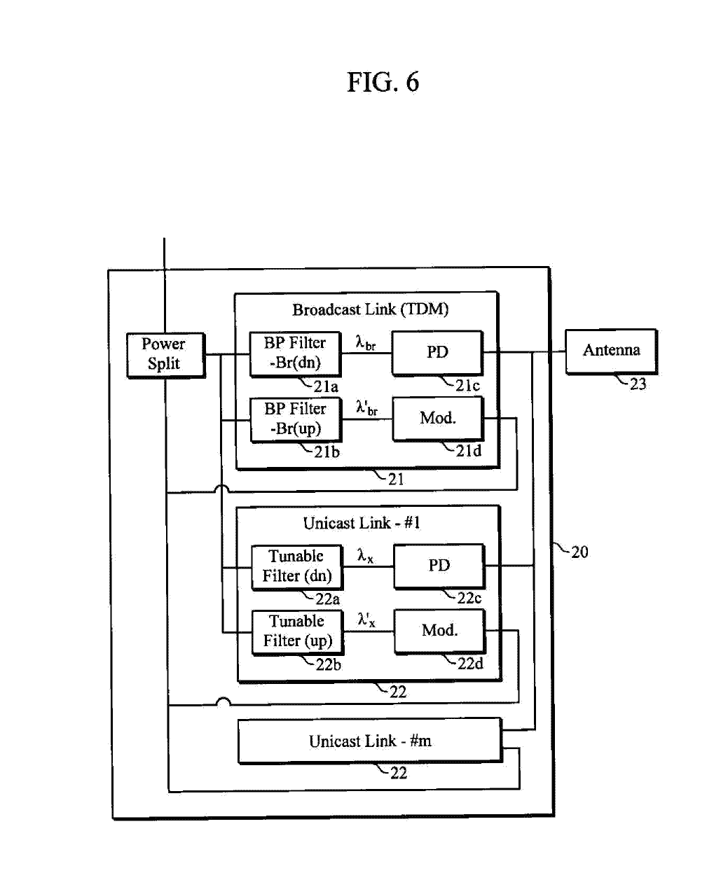

FIG. 6 is a block diagram illustrating a separated-type base station according to an exemplary embodiment. In the case where the central base station 10 is configured as illustrated in FIG. 5, the device in the separated-type base station may be configured as illustrated in FIG. 6, in which the device includes a single broadcast link module 21 and a plurality of unicast link modules 22. The broadcast link module 21 includes fixed-type upstream/downstream filters 21a and 21b, a control channel receiving module (photodiode, PD) 21c, and an upstream transmission modulator 21d. The unicast link module 22 includes tunable upstream/downstream filters 22a and 22b, a data channel receiving module 22c, and an upstream transmission modulator (Mod.) 22d. Accordingly, upstream transmission may be performed by using an allocated upstream wavelength without a separate optical transmitter. Further, received data may be transmitted directly through an antenna 23.

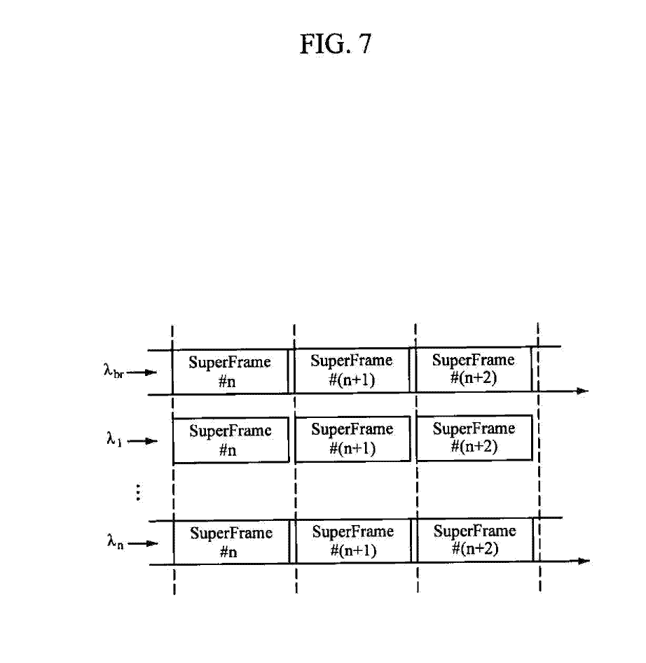

Hereinafter, Medium Access Control (MAC) protocol will be described, which is used for allocation of wavelengths and bandwidths of the optical link MAC unit 300 and covers different wireless MACs. Data is transmitted over the optical link in superframes as illustrated in FIG. 7. Other than a control wavelength (λ_{Br}), wavelengths in a data channel may be allocated to the separated-type base stations 20 in time units of superframes. In this case, superframes of wavelengths are required to be synchronized as shown by a dotted line in FIG. 7. In both downstream and upstream channels, data is transmitted and received in synchronized superframes.

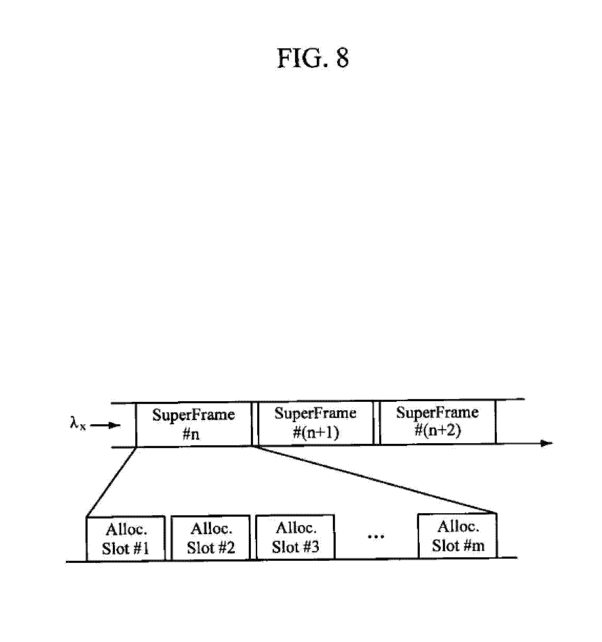

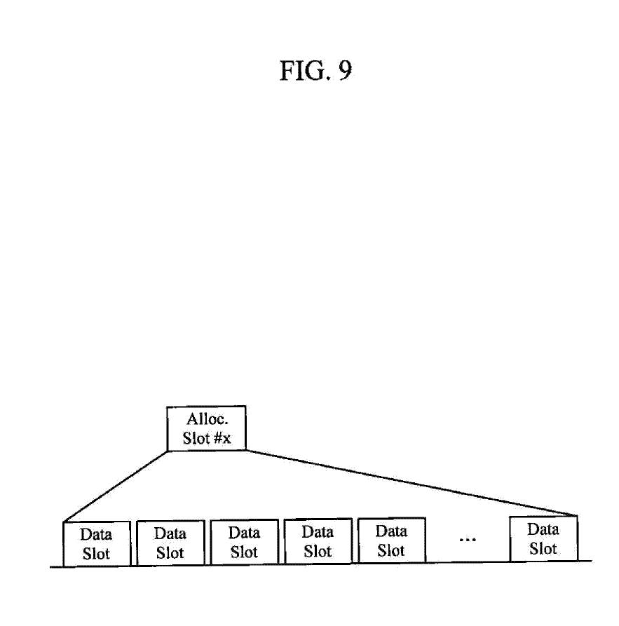

Each superframe of a certain wavelength includes an “m” number of allocation slots as illustrated in FIG. 8. An allocation slot has a size of 20 ms so that an LTE wireless frame may be available. At data wavelengths of λ₁ to λₙ, one allocation slot transmits optical and wireless MAC frames. For this reason, based on characteristics of each wired and wireless MAC, one allocation slot may include a plurality of data slots as illustrated in FIG. 9. For example, XGPON frame of 125 us may include 160 data slots for the allocation slot of 20 ms.

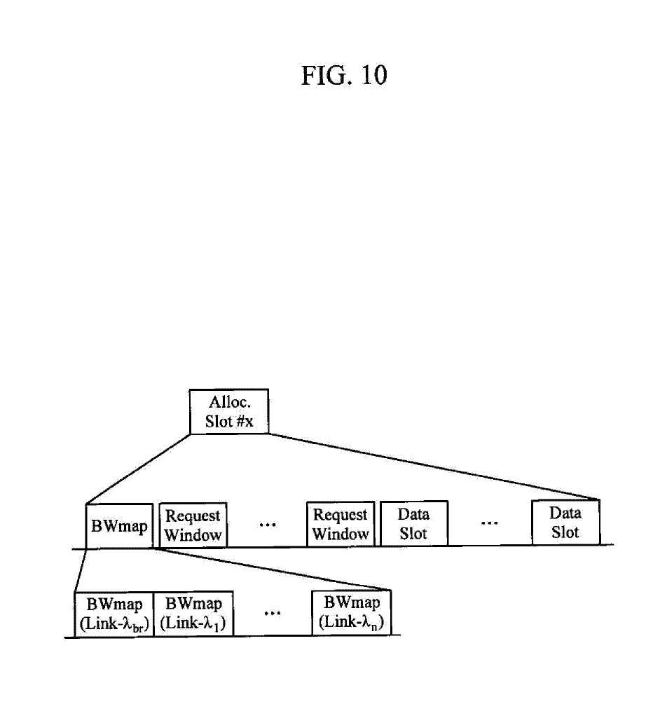

Wavelength allocation information of the central base station and bandwidth request information of the separated-type base stations are exchanged in a control channel that is broadcast. As illustrated in FIG. 10, an allocation slot in a control wavelength channel is composed of a bandwidth map (BWmap), Request Windows, and Data Slots. The BWmap includes wavelength allocation information in a time domain. The central base station 10 performs downstream transmission of information on the BWmap for each wavelength channel. In the Request Windows, information on a bandwidth request or session setting of the separated-type base stations may be exchanged. Remaining spaces in a downstream control channel are used as data slots for transmitting data to one or more separated-type base stations that require such data. Remaining spaces in an upstream control channel are maintained empty so that the spaces may be used to immediately respond to Request Windows, and only selected separated-type base stations transmit upstream data by using the remaining spaces.

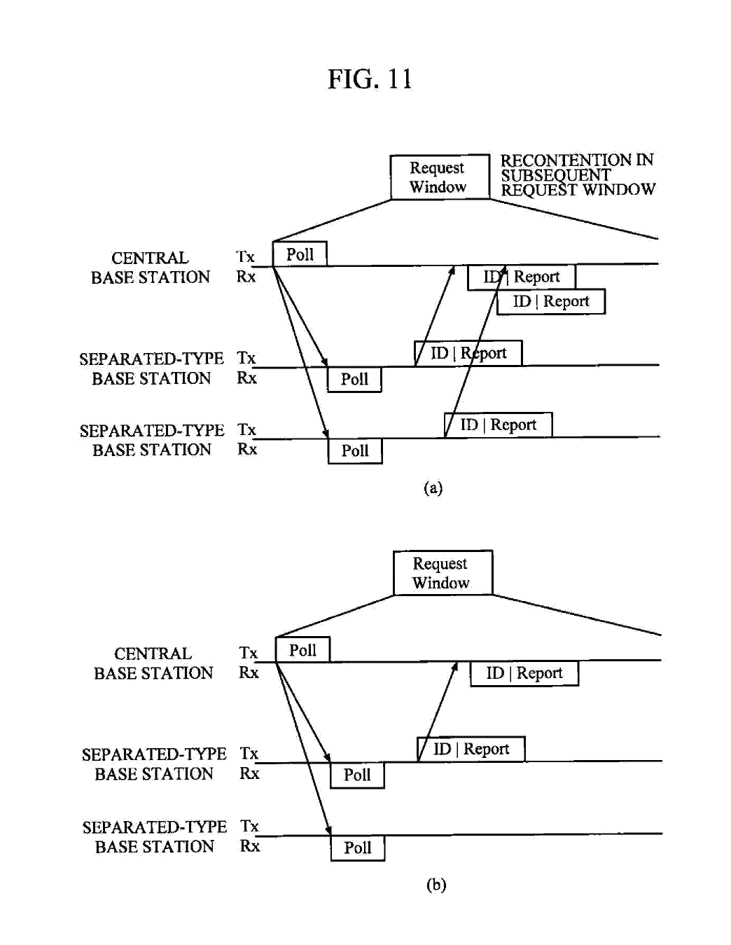

FIG. 11 is a diagram illustrating a Request Window procedure according to an exemplary embodiment. A Request Window in a control wavelength channel is used to obtain bandwidth request information of the separated-type base stations, and is operated based on contention. In FIG. 11, (a) illustrates an example where a Request Window procedure is failed, and (b) illustrates an example where a Request Window procedure succeeds. In the case where a message collision occurs as illustrated in (a) of FIG. 11, contention continues in a subsequent Request Window. Contention is repeated a number of times that is a number of Request Windows included in one allocation slot, and wavelength resources are allocated based on the contention.

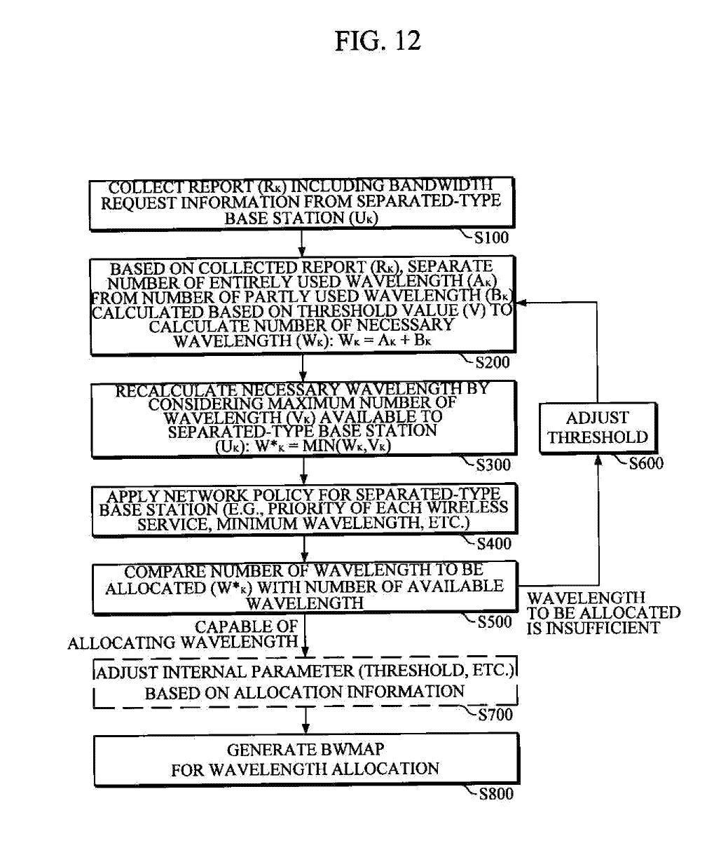

Hereinafter, a wavelength allocation method performed by the dynamic wavelength allocator 100 will be described with reference to FIG. 12. The dynamic wavelength allocator 100 collects a report from separated-type base stations by using the aforementioned MAC architecture in S100. The report includes bandwidth request information. Then, based on a number of entirely used wavelengths and a threshold value included in the collected bandwidth request information, the dynamic wavelength allocator 100 calculates a number of partly used wavelengths in S200. For example, in the case where an amount of 100 may be transmitted through a wavelength channel, a requested amount is 330, and a threshold value is 50, a number of entirely used wavelengths is 3, and a number of partly used wavelengths is 0. In another example, in the case where a requested amount is 370, a number of entirely used wavelength is 3, and a number of partly used wavelength is 1. The partly used wavelengths are necessary to improve utilization efficiency of wavelength resources by delaying or excluding wavelength allocation when wavelength resources are insufficient. Next, the dynamic wavelength allocator 100 recalculates a number of wavelengths to be allocated in S300 by considering a maximum number of wavelengths available to the separated-type base stations. The maximum number should be considered because, if two wavelengths may be available in the separated-type base stations although three wavelengths are desired to be allocated, only two wavelengths may be used even though three wavelengths are allocated. Then, the dynamic wavelength allocator 100 applies a network policy in S400. For example, the policy may include prioritizing wavelengths by applying different weighted values to wireless services, ensuring minimum necessary wavelengths to a specific area, and the like.

After a number of wavelengths to be allocated is calculated as described above, the dynamic wavelength allocator 100 compares the calculated number of wavelengths with a number of available wavelengths in S500. Upon comparison, if wavelengths may be allocated, the dynamic wavelength allocator 100 generates a BWmap for allocating wavelengths, and allocates wavelengths in S800. If wavelengths to be allocated are insufficient, the dynamic wavelength allocator 100 adjusts a threshold value and calculates again. The threshold may be adjusted by stages in S600. However, if a threshold adjustment loop is repeated more than a specific number of times, the dynamic wavelength allocator 100 may further adjust a part of the whole network policy in S700.

Assuming that one wavelength provides a transmission capacity of 10 Gbits/s to separated-type base stations to provide a communication service environment of 1 Gbits/s per mobile subscriber, investments are required to be made in network equipment for more mobile subscribers who wish to receive high-quality multimedia services. In the near future, when a communication environment for Internet of Things (IoT) and Machine to Machine (M2M) is established, there will be more mobile traffic. In the case where such a large amount of traffic is concentrated on some separated-type base stations at a certain time according to a movement pattern of users, many mobile subscribes may experience degraded quality of service. Further, in a network structure where there is no processing module that is included in the separated-type base stations to perform complicated functions, such as transmitting data, received from the central base station, directly through an antenna, or transmitting data, received through an antenna, directly to the central base station, utilization efficiency of wavelengths may not be improved by Time-Division Multiplexing (TDM). In this case, increased installation costs of a plurality of separated-type base stations may lower a rate of return on investment.

In the present disclosure, by allocating one or more wavelength resources to separated-type base stations according to needs while sharing multiple wavelength resources in the central base station, utilization efficiency of wavelengths may be improved, thereby enabling efficient operations, with reduced requirement for additional network installation costs. Further, unused wavelength resources may be relieved, thereby achieving a power saving effect in the network. In addition, the present invention provides an architecture where various wireless MAC frames, such as LTE or WiFi, may be transmitted to the separated-type base stations through an optical link, which may also be applied to Centralized/Cloud Radio Access Network (C-RAN) architecture.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. A central base station apparatus comprising:
a network communicator configured to transmit and receive a signal with separated-type base stations; and
a dynamic wavelength allocator configured to dynamically allocate one or more wavelengths to the separated-type base stations through the network communicator based on bandwidth request information of each of the separated-type base stations.

2. The apparatus of claim 1, wherein the dynamic wavelength allocator determines a number of upstream wavelength resources to be allocated to the separated-type base stations according to the bandwidth request information based on an amount of used traffic of the separated-type base stations.

3. The apparatus of claim 2, wherein the network communicator comprises:
a first optical transceiver configured to allocate a control wavelength; and
a second optical transceiver configured to allocate a data wavelength.

4. The apparatus of claim 3, wherein after allocating wavelength resources through the first optical transceiver, the dynamic wavelength allocator allocates a number of wavelength resources, determined according to the amount of used traffic of the separated-type base stations, through the second optical transceiver.

5. The apparatus of claim 4, wherein:
the first optical transceiver is a single optical transceiver to allocate one wavelength resource; and
the second optical transceiver comprises a plurality of optical transmission modules to allocate different wavelength resources.

6. The apparatus of claim 5, wherein:
the first optical transceiver is a broadcast optical module; and
the second optical transceiver is a unicast optical module.

7. The apparatus of claim 6, wherein the dynamic wavelength allocator allocates upstream wavelength resources while transmitting a downstream signal to the separate-type base stations.

8. The apparatus of claim 6, wherein a broadcast control channel is used to exchange wavelength allocation information and the bandwidth request information between the central base station and the separated-type base stations.

9. The apparatus of claim 6, wherein the dynamic wavelength allocator allocates the wavelength resources to the separated-type base stations through the second optical transceiver by using synchronized superframes of wavelengths.
